(19) United States
(12) Patent Application Publication
(10) Pub. No.: US 2021/0232659 A1
(43) Pub. Date: Jul. 29, 2021

(54) QUERY RECOMMENDATIONS FOR A DISPLAYED RESOURCE

(71) Applicant: Google Inc., Mountain View, CA (US)

(72) Inventors: Michal Jastrzebski, Zurich (CH); Gokhan H. Bakir, Zurich (CH); Marcin M. Nowak-Przygodzki, Zurich (CH)

(21) Appl. No.: 15/215,797

(22) Filed: Jul. 21, 2016

(51) Int. Cl. G06F 17/30

(52) U.S. Cl. CPC G06F 17/3053; G06F 17/30448; G06F 17/30554

(57) ABSTRACT

Methods, systems, and apparatus, including computer programs encoded on a computer storage medium, for providing contextual information to a user. In one aspect, a method includes receiving, from a user device, a query-independent request for contextual information relevant to an active resource displayed in an application environment on the user device, generating a first set of queries from displayed content from the resource, generating a second set of queries from the first set of queries, determining a quality score for each of the queries of the second set of queries, selecting one or more of the queries from the second set of queries based on their respective quality scores, and providing, to the user device for each of the selected one or more queries of the second set of queries, a respective user interface element for display with the active resource.

### BACKGROUND

This specification relates to providing contextual information to a user.

A device may provide a user with contextual information. For example, a device may display a web page about a particular subject, receive a search query from the user including search terms for the particular subject, retrieve search results responsive to the search query, and provide the search results to the user.

Typical interaction models require users to provide some form of a user query to a user device. For example, a user may be viewing article about a particular piece of sporting equipment on a smart phone and state “show me reviews about this item.” A search process then analyzes the article, and the query which is dependent on the article, to determine search parameters and execute a search of resources to identify resources that may satisfy the user's informational needs.

### SUMMARY

In general, one innovative aspect of the subject matter described in this specification can be embodied in methods that include the actions of receiving, from a user device, a query-independent request for contextual information relevant to an active resource displayed in an application environment on the user device, generating a first set of queries from displayed content from the resource, generating a second set of queries from the first set of queries, determining a quality score for each of the queries of the second set of queries, selecting one or more of the queries from the second set of queries based on their respective quality scores, and providing, to the user device for each of the selected one or more queries of the second set of queries, a respective user interface element for display with the active resource, where each user interface element includes contextual information regarding the respective query and includes the respective query.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In certain aspects generating a second set of queries from the first set of queries includes identifying queries that are submitted by users after the users submit queries from the first set of queries and generating the second set of queries from the queries that are identified as submitted by users after the users submit queries from the first set of queries. In some aspects the second set of queries includes queries that do not include terms that appear in the displayed content from the resource. In some implementations determining a quality score for each of the queries of the second set of queries includes determining a frequency that a particular query of the second set of queries is submitted after a query of the first set of queries is submitted and determining the quality score for the particular query based on at least the frequency that the particular query of the second set of queries is submitted after the query of the first set of queries is submitted.

In certain aspects, determining a frequency that a particular query of the second set of queries is submitted after a query of the first set of queries is submitted includes determining, for each query of the first set of queries, a frequency that a particular query of the second set of queries is submitted after the respective query of the first set of queries is submitted and aggregating the frequencies for each of the first set of queries to determine the frequency that the particular query of the second set of queries is submitted after a query of the first set of queries is submitted. In some aspects, determining a quality score for each of the queries of the second set of queries includes determining the quality score for a particular query of the second set of query based at least on a visual appearance of the terms from which a particular query of the first set of queries was generated, the particular query of the first set of queries the query from which the particular query of the second set of query was generated. In some implementations, determining a quality score for each of the queries of the second set of queries includes determining a quality of search results responsive to each query of the second set of queries and determining the quality score for each of the queries of the second set of queries based at least on the quality of search results responsive to the respective query. In certain aspects, receiving, from a user device, a query-independent request for contextual information relevant to an active resource displayed in an application environment on the user device includes receiving, from the user device, a query-independent request that does not include one or more query terms entered by a user. In some aspects, the resource includes one or more of a web page, an application page, or a textual conversation. In some implementations, generating a second set of queries from the first set of queries includes generating, for each of the queries of the first set of queries, a set of queries from the respective query and aggregating the sets of queries from the respective queries as the second set of queries.

Particular embodiments of the subject matter described in this specification can be implemented so as to realize one or more of the following advantages. Contextual information that is likely to help satisfy a user's informational need when viewing a displayed resource on a device may be provided by the device to a user without the user providing a query to the device. The contextual information provided by the device may be in the form of interface elements that can be selected to request resources responsive to search queries recommended by a system. The search queries recommended by the system may be queries that were previously submitted by other users after the other users submitted an initial query that includes content in the displayed resource being viewed by the user. The resources responsive to the recommended search queries may satisfy the user's information need. Accordingly, this results in a convenient way for the user to obtain resources that may satisfy the user's informational need. Contextual information may also include data describing certain facts, images and search results.

In particular, the system enables the input of a query-independent request for contextual information that is relevant to an active resource displayed on the user device in a fluid and intuitive manner. The user no longer needs to type in query terms or speak query terms to obtain resources that satisfy the user's informational needs. Accordingly, users are more likely to solicit information to satisfy their information needs as doing so can be accomplished in a manner that is not only convenient for the user, but also in a relatively discrete manner so that bystanders are not disturbed by the user speaking into the device. Also, because the user need not type in a query, the user may, in some implementations, solicit the information when the user would otherwise be unable to type effectively, e.g., when the user only has one hand free.

Also, because the input of the query-independent request for contextual information results in a selection by the user of a recommended query, the system does not need to perform text-to-speech processing or process typing input. This results in fewer input errors and erroneously input queries. Accordingly, when considered in the aggregate, thousands of erroneous and inaccurate queries are avoided, which in turn provides a more efficient use of search system resources. In other words, multiple erroneous query processing cycles are avoided, which reduces processing resources required and reduces overall system bandwidth requirements (or, alternatively, enables a larger number of users to be serviced without a commensurate increase in processing resources). This improvement in the technological field of search processing is thus another distinct advantage realized by the systems and methods described below.

Additionally, because the system may recommend queries that were previously submitted by other users after the other users submitted an initial query that includes content in the displayed resource being viewed by the user, the system may cause the user to submit the recommended query without first submitting the initial query. For example, the system may recommend a query that is typically submitted as a refinement to a query that only includes terms in a displayed resource. Additionally, the system may recommend queries that are more likely to provide results that satisfy informational needs of the user. For example, the system may avoid recommending search queries that have few or no results and avoid recommending search queries that are frequently followed by refined search queries. Accordingly, the system may reduce the need for users to try multiple different queries in an attempt to satisfy their information need. Thus, the system may reduce the time, processing, and bandwidth needed for a user to obtain information that satisfies their informational needs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which contextual information is provided for a displayed resource.

FIG. 2 is a more detailed block diagram of the example environment in which contextual information is provided for a displayed resource.

FIG. 3 is a flow diagram of an example process for providing contextual information for a displayed resource.

FIG. 4 is a schematic diagram of a computer system.

Like reference numbers and designations in the various drawings indicate like elements.

### DETAILED DESCRIPTION

Sometimes a user may desire to receive additional information regarding the subject matter of a resource that the user is currently viewing on a device. For example, a user may be viewing a web page mentioning that the “Plexus 6X,” a particular make and model of a mobile user device, is now available for preorder and may desire to obtain additional information about what phones have upcoming releases. The user may open a web page for a search engine, type in “Best upcoming phones” as a search query, scroll through a search results listing, and then select a search result to view. However, this process may be time consuming and require multiple interactions by the user.

Described below are systems and methods for providing contextual information, such as a selectable query, or a set of selectable actions, for a displayed resource. Instead of providing contextual information based on a query entered by a user, the system may provide contextual information for a displayed resource and independent of a query input in which a user specifies a particular query. Moreover, the system can predict what a user's next action or query will be based on the content of the displayed resources, where the next action or query may not be directly derived from content of the displayed resource.

To provide the contextual information, the system detects that a user desires contextual information. For example, a user viewing a webpage about preordering the “Plexus 6X” on their phone may press a button for three seconds, or provide some other indication like pressing a dedicated button or performing a particular gesture, to indicate that the user wishes to receive contextual information based on the displayed webpage. The system may detect the indication and, in response, recommend search queries that were previously submitted by other users after the other users submitted an initial query that includes content in the displayed resource being viewed by the user. For example, the system may identify that the term “Plexus 6X” is being displayed and determine that many users submit the query “Plexus” and then submit a query for “Best upcoming phones.” Based on these determinations, the system provides an interface element that includes the query “Best upcoming phones” to the device and an element that can be selected to request results for the query. In another example, the system may identify that the term “Plexus 6X” and “Preorder” are both being displayed and determine that many users that submit the query “Plexus 6X preorder” then submit a query for “Plexus 6X discount.” Based on these determinations, the system provides an interface element that includes the query “Plexus 6X discount” to the device and an element that can be selected to request results for the query.

These features and additional features are described in more detail below.

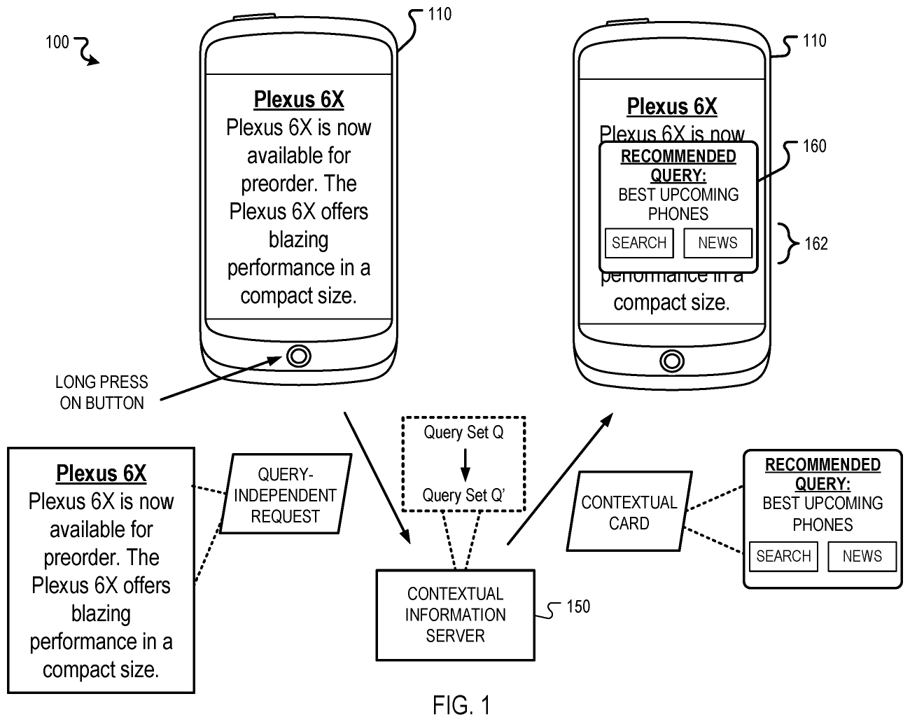

FIG. 1 is a block diagram of an example environment 100 in which contextual information is provided for a displayed resource. The environment 100 includes a user device 110 and a contextual information server 150.

A user device 110 is used by a user to obtain contextual information for a displayed resource. The user device 110 is an electronic device that is capable of requesting and receiving resources over the network. Example user devices 110 include personal computers (e.g., desktops or laptops), mobile communication devices (e.g., smart phones or tablets), and other devices that can send and receive data over the network (e.g., televisions, and glasses or watches with network communication functionality). A user device typically includes a user application, e.g., a web browser, to facilitate the sending and receiving of data over the network. The web browser can enable a user to display and interact with text, images, videos, music and other information typically located on a web page at a website on the World Wide Web or a local area network. The user device 110 may use any appropriate application to send and receive data over the network and present requested resources to a user.

A resource is data that includes content that can be visibly rendered by the user device 110. For example, resources may include HTML pages, electronic documents, images files, video files, text message conversations, e-mails, graphical user interfaces of applications, etc. An active resource may be considered a resource that is currently being displayed on the user device 110. Typically, the active resource is rendered by an application that is running in a foreground of a user device.

The user device 110 detects that a user desires contextual information for an active displayed resource. For example, the user device 110 may be displaying a resource hosted by a website, where the resource includes text in the active viewport that describes that the “Plexus 6X” is now available for preorder. The user may generate an indication of desiring contextual information, e.g., by pressing a button for three seconds or tapping the screen according to a predefined tap patter, etc. Assume for illustrative purposes the user performs a long press that indicates that the user desires contextual information for a displayed resource. In response, the user device 110 provides a request to the contextual information server 150 for contextual information for the displayed resource. For example, the user device 110 may provide a request that includes a screenshot of the currently displayed portion of the active resource, where the portion includes the text “Plexus 6X is now available for preorder.” In this example, information in the active window of the active resource is used to generate queries for contextual information, which will be described in more detail below. However, other information can also be used to generate queries, such as the text of the active resource, including text not displayed in the active window, the URI of the resource, and the like.

The request may be considered a query-independent request as the user device 110 provides the request to the contextual information server 150 without having the user enter terms for a query, whether verbally, physically, or some other interaction. For example, after the user device 110 detects that a user has long pressed a button, the user device 110 may provide the request to the contextual information server 150 without requesting additional information from the user.

In response to providing the request to the contextual information server 150, the contextual information server 150 generates a first set of multiple queries (as an example labeled Q) from the request. For example, the contextual information server 150 may generate a set of multiple queries that includes all combinations of text that the request indicates is currently displayed on the user device 110. The contextual information server 150 may then generate a second set of multiple queries (as an example labeled Q′) from the first set of queries. For example, the contextual information server 150 may identify queries that are frequently submitted after one or more of the queries in the first set of multiple queries. The contextual information server 150 then selects one of the queries of the second set of multiple queries and provides a user interface element for the selected query.

The user device 110 then receives the user interface element from the contextual information server 150. The user interface element may include a recommended search query identified based on content in the displayed resource text and contextual information in the form of a navigation link that may be selected to request results for the search query. For example, the user device 110 may receive a user interface element that includes the text “Recommended Query” and “Best upcoming phones,” and navigation links for searching for resources using the query “Best upcoming phones” and searching for news articles using the query “Best upcoming phones.”

For the purposes of illustration, the user interface element is described as a card. However, other user interface elements may be used, for example, chat bubbles, selectable linked notes or footnotes, synthesized voice responses, or other forms. In some implementations, instead of a single user interface element that includes multiple navigation links, a user interface element may include a single navigation link and multiple user interface elements may be received for different resources.

The user device 110 displays the received contextual card to the user. For example, the user device 110 may generate a graphical panel 160 that is shown overlaid on top of the displayed resource where the graphical panel 160 includes navigation links for the query recommended by the card. In another example, the user device 110 may stop displaying the resource and instead display the graphical panel 160. The user device 110 may enable the user to quickly return to the displayed resource. For example, the user device 110 may stop displaying the graphical panel 160 in response to detecting that a user has interacted with, e.g., clicked or touched, a portion of the resource that is not overlaid by the graphical panel 160. In another example, the user device 110 may stop displaying the graphical panel 160 and display the resource in response to detecting that a user has interacted with, e.g., clicked or touched, a selectable option for closing the graphical panel 160. In some implementations, the contextual information server 150 may select multiple queries from the second set of multiple queries and the user device 110 may receive and display a contextual card for each of the selected queries.

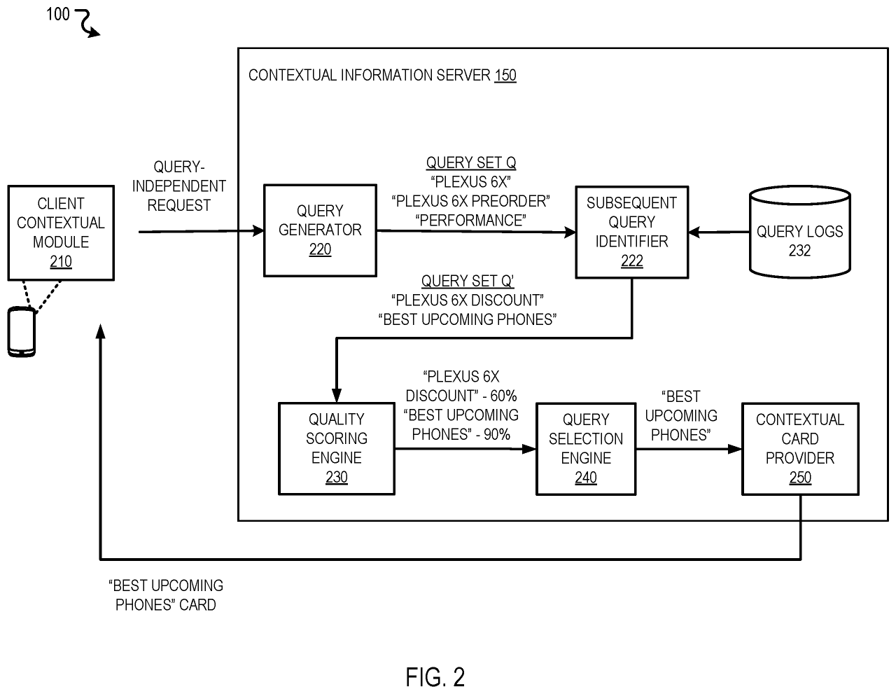

FIG. 2 is a more detailed block diagram of the example environment 100 in which contextual information is provided for a resource. The environment 100 includes a client contextual module 210 on a user device and a contextual information server 150. The contextual information server 150 includes a query generator 220, a subsequent query identifier 222, a quality scoring engine 230, a query selection engine 240, and a contextual card provider 250. In some implementations, the client contextual module 210 may be provided on the user device 110 shown in FIG. 1.

The client contextual module 210 determines that a user desires contextual information for a displayed resource. For example, the client contextual module 210 may determine that a user has rapidly pressed a button three times when viewing a webpage about the “Plexus 6X” being available for preorder (in this example, rapidly pressing the button three times indicates that the user desires contextual information). In response to determining that a user desires contextual information for a displayed resource, the client contextual module 210 generates a request to the contextual information server 150 for contextual information for the displayed resource. For example, the client contextual module 210 may generate a request to the contextual information server 150 for contextual information for the webpage that describes that the “Plexus 6X” is available for preorder.

The client contextual module 210 may include information about the displayed resource in the request. For example, the client contextual module 210 may generate a screenshot that is an image showing the webpage and include the screenshot in the request. In another example, the client contextual module 210 by request that the operating system of the user device provide a tree based document object model that defines what is currently being rendered in an application that is in a foreground and include the model in the request. The document object model may define text that appears in the displayed resource and the appearance of the text, e.g., size, color, position, font, or other formatting, of the text. In yet another example the client contextual module 210 may include various handlers, such as text handlers and image handlers, to determine text and image data displayed in the active window of the device and provide the text and image data as part of the request.

In some implementations, the client contextual module 210 may include the information about the displayed resource in the request by determining a source of the displayed resource and including an indication of the source of the request. For example, the client contextual module 210 may determine that displayed resource is provided by a web browser application, in response, determine that the web browser application can provide a uniform resource locator (URL) for the displayed resource, and, in response, include an indication in the request that the source of the active resource is the web browser application and the URL for the displayed resource. Information may additionally or alternatively include metadata describing the displayed resource, a location of the user device, a portion not currently displayed of the resource, or an identity of the user. For example, the client contextual module 210 may determine that the user device 110 is located in Atlanta and include a location of “Atlanta” in the request.

The client contextual module 210 then provides the request to the query generator 220 without the user entering a query. For example, the client contextual module 210 provides the request to the query generator 220 in response to the user providing the indication that the user desires contextual information for the displayed resource, e.g., three rapid button presses, a long button press, or some other indication, without the user providing any further information, e.g., query terms, after providing the indication.

In response to providing the request to the query generator 220, the client contextual module 210 receives a contextual card and renders the contextual card. For example, the client contextual module 210 receives a contextual card that includes a query “Best upcoming phones” and navigation links to request search results or news results for the query. As will be described below, the contextual card is generated by the contextual information server 150 in response to the query independent request.

The query generator 220 receives the query independent request for contextual information for a displayed resource and generates a first set of multiple queries (as an example labeled Q) from the content of the displayed resource. For example, the query generator 220 may receive a screenshot including the text “Plexus 6X is now available for preorder. The Plexus 6X offers blazing performance in a compact size” and generates queries of “Plexus 6X,” “Plexus 6X Preorder,” and “Performance.”

The query generator 220 may generate queries by combining text from the displayed resource in various combinations. For example, the query generator 220 may receive a screenshot including the text “Plexus 6X is now available for preorder. The Plexus 6X offers blazing performance in a compact size,” perform optical character recognition to extract the text from the screenshot, and then generate the query “Plexus 6X Preorder” by combining “Plexus 6X” and “Preorder” from the text. In another example, the query generator 220 may receive a document object model that includes the text “Plexus 6X is now available for preorder. The Plexus 6X offers blazing performance in a compact size,” and select “Plexus 6X” from the text as the query.

In some implementations, the query generator 220 may use natural language grammar rules to generate the queries. The query generator 220 may generate queries with terms with different tenses or pluralities than terms in the displayed resource. For example, the query generator 220 may generate the query “blaze Plexus size” from “blazing,” “Plexus,” and “size” in the displayed resource.

In other implementations, the query generator 220 may generate a set of all possible n-grams from the text. In still other implementations, stop words may be removed from the text and the remaining text may be used to generate the queries. Other appropriate query generation techniques may also be used.

The subsequent query identifier 222 may receive the first set of multiple queries from the query generator 220 and generate a second set of multiple queries (as an example labeled Q′) from the first set of multiple queries. For example, the subsequent query identifier 222 may receive the first set of multiple queries of “Plexus 6X,” “Plexus 6X preorder,” and “Performance” and, in response, generate a second set of multiple queries of “Plexus 6X discount” and “Best upcoming phones.” In some implementations, for each query that the subsequent query identifier 222 receives, it generates a corresponding set of subsequent queries for that query. Thus, if n queries are received, then n multiple sets of subsequent queries are identified.

The subsequent query identifier 222 may generate the second set of multiple queries based on identifying queries that are submitted to a search engine after queries of the first set of queries Q are submitted to the search engine. For example, the subsequent query identifier may identify the query “Plexus 6X discount” is frequently used as a search query after users search using the query “Plexus 6X preorder” and, in response, include the query “Plexus 6X discount” in the second set of multiple queries.

The subsequent query identifier 222 may identify queries that are submitted to search engines after queries of the first set of queries are submitted to the search engine based on search query logs stored in the query log database 232. The subsequent query identifier 222 may analyze search query logs that record a history of searches to identify when a user submits a query and then identify the next search query that the user submits. For example, the subsequent query identifier 222 may determine that a particular user submitted the query “Plexus 6X preorder” on Jan. 1, 2016 at 1:00 PM ET, the next query that the particular user submitted after Jan. 1, 2016 at 1:00 PM ET was submitted at 1:02 PM ET that same day, and then identify the query submitted at 1:02 PM ET was “Plexus 6X discount.”

The quality scoring engine 230 receives the second set of multiple queries from the subsequent query identifier 222 and determines quality scores for each of the queries. For example, the quality scoring engine 230 may receive the queries “Plexus 6X discount” and “Best upcoming phones” from the subsequent query identifier 222 and determine a quality score of 60% for “Plexus 6X discount” and a quality score of 90% for “Best upcoming phones.” A quality score for a query may reflect a confidence that the query will identify resources that satisfy a user's informational need. For example, a quality score of 60% may reflect a medium confidence that the query will identify resources that satisfy a user's informational need and a quality score of “90%” may reflect a high confidence that the query will identify resources that satisfy a user's informational need. Alternatively a quality score for each query may be simply be a value that indicates a quality of the query relative to the quality of other queries, and need not represent a confidence that the query will identify resources that satisfy a user's informational need. Other appropriate metrics of quality for a query may also be used for quality scores.

The quality scoring engine 230 may determine the quality score for a search query based on one or more of a frequency that the search query is submitted after a query from the first set of search queries is submitted, a speed that the search query is submitted after a query from the first set of search queries is submitted, a number of search results responsive to the search query, the underlying quality of the references referenced by the search results, a popularity of the search query, user behavior regarding search results of the search query, the prominence of the content in the displayed resource, and the like. In some implementations, the quality score may be based on a combination of two or more of these factors.

For determining the quality score based on a frequency that the search query is submitted after a query from the first set of search queries is submitted, the quality scoring engine 230 may determine quality scores that reflect a higher degree of confidence for queries that are more frequently submitted after a query from the first set of queries is submitted and determine quality scores that reflect a lower degree of confidence for queries that are less frequently submitted after a query from the first set of queries is submitted. For example, the quality scoring engine 230 may determine a quality score reflecting a high degree of confidence for a query “Best upcoming phones” that is frequently submitted by users after users submit the query “Plexus 6X” and determine a quality score reflecting a low degree of confidence for a query “Plexus 6X discount” that is less frequently submitted by users after users submit the query “Plexus 6X.” In some implementations, the frequency that the search query is submitted after a query from the first set of search queries is submitted may refer to the number of times that query of the second set of queries is submitted after the query from the first set of queries is submitted. In some implementations, the frequency that the search query is submitted after a query from the first set of search queries is submitted may refer to the percentage of times that query of the second set of queries is submitted after the query from the first set of queries is submitted.

For determining the quality score based on a speed that the search query was submitted after a query from the first set of search queries is submitted, the quality scoring engine 230 may determine quality scores that reflect a higher degree of confidence for queries that are more quickly submitted after a query from the first set of queries is submitted and determine quality scores that reflect a lower degree of confidence for queries that are less quickly submitted after a query from the first set of queries is submitted. For example, the quality scoring engine 230 may determine a quality score reflecting a high degree of confidence for a query “Best upcoming phones” that is on average submitted by users within a minute, two minutes, ten minutes, or some other period of time after users submit the query “Plexus 6X” and determine a quality score reflecting a low degree of confidence for a query “Plexus 6X discount” that is on average submitted by users outside that time period after users submit the query “Plexus 6X.”

For determining the quality score based on a number of search results responsive to the search query, the quality scoring engine 230 may determine quality scores that reflect a higher degree of confidence for queries that have more search results that meet a minimum quality score and determine quality scores that reflect a lower degree of confidence for queries that have fewer search results that meet the minimum quality score. For example, the quality scoring engine 230 may determine a quality score reflecting a high degree of confidence for a query “Best upcoming phones” that results in many search results with relative high quality scores and a quality score reflecting a low degree of confidence for a query “Plexus 6X discount” that results in fewer search results that meet the minimum quality score. The quality scoring engine 230 may provide the search query to a search engine to determine that number of search results for the search query. For example, the quality scoring engine 230 may provide the query “Best upcoming phones” to a search engine and receive a response indicating that there are a high number of higher quality search results responsive the query, and in response, determine a quality score reflecting a high degree of confidence for the query.

For determining the quality score based on a popularity of the search query, the quality scoring engine 230 may determine quality scores that reflect a higher degree of confidence for queries that are currently more popular than queries that are currently less popular. For example, the quality scoring engine 230 may determine a quality score reflecting a higher degree of confidence for a query “Best upcoming phones” that many people have submitted as a search query in the past week and a quality score reflecting a lower degree of confidence for a query “Plexus 6X discount” that few people have submitted as a search query in the past week. The quality scoring engine 230 may determine popularity of queries based on information from the query log database 232 that stores queries made by various users.

For determining the quality score based on user behavior regarding search results of the search query, the quality scoring engine 230 may determine quality scores that reflect a higher degree of confidence for queries where users did not provide refined search queries and may determine quality scores that reflect a lower degree of confidence for queries where users provided refined search queries. The quality scoring engine 230 may determine whether users provided refined search results based on query search history stored in the query log database 232.

For determining the quality score based on an appearance of content in the displayed resource, the quality scoring engine 230 may determine quality scores that reflect a higher degree of confidence for queries identified from queries that include terms that appear to be from a title in a displayed resource. For example, the quality scoring engine 230 may determine that particular displayed text appears to be underlined and centered, and in response, determine that the particular displayed text is part of a title and determine a higher degree of confidence for queries that are identified as subsequent queries to queries that include terms from the particular displayed text.

In some implementations, the quality scoring engine 230 may determine that particular displayed text appears different than the majority of other displayed text and, in response, determine quality scores that reflect higher degrees of confidence for queries that are identified from queries that include terms from the particular displayed text. For example, the quality scoring engine 230 may determine that particular displayed text is bolded and the majority of displayed text is not bolded and, in response, determine quality scores that reflect higher degrees of confidence for queries that are identified as subsequent queries to queries that include terms from the particular displayed text. In some implementations, the quality scoring engine 230 may determine quality scores that reflect a greater degree of confidence for queries identified from queries that include terms that appear more frequently in the displayed resource. In some implementations, the quality scoring engine 230 may determine quality scores that reflect a greater degree of confidence for queries that include terms that appear more frequently in the displayed resource.

In some implementations, the quality scoring engine 230 may determine a query of the second set of queries is submitted after multiple, different queries of the first set of queries and determine a quality score based on that determination. For example, the quality scoring engine 230 may determine a quality score for a particular query of the second set of queries based on a sum of the number of times that the particular query of the second set of queries is submitted after a first query of the first set of queries and the number of times that the particular query of the second set of queries is submitted after a second query of the first set of queries. In another example, the quality scoring engine 230 may determine a quality score based on a lowest average time between the average time that the particular query of the second set of queries is submitted after a first query of the first set of queries and the average time that the particular query of the second set of queries is submitted after a second query of the first set of queries.

In some implementations, the query scoring engine 230 may determine the quality scores by computing the set of queries that were issued the most of number of times after each query from a set Q of queries generated from content in the displayed resource. For example, query scoring engine 230 may determine set R={(r_1, t_11), (r_2, t_21), . . . } where r_j represents a query of the second set of queries that is submitted after a query q_i of the first set of queries and t_ij represents the number of transitions from the query q_i to the query r_j in the search query logs. A function S(t, (r_i, t_ij)) may be defined that assigns quality scores using input of (i) the text in the displayed resource, (ii) a query r_j of the second set of queries, and (iii) the number of transitions t_ij from the query q_i to the query r_j. The set R may then be provided with text of the displayed resource to the function S to determine quality scores for each of the queries of the second set of queries.

The query selection engine 240 may obtain the quality scores from the quality scoring engine 230 and select one or more queries of the second set of multiple queries to recommend to the user. For example, the query selection engine 240 may receive an identification of “Plexus 6X discount” with the quality score 60% and “Best upcoming phones” with the quality score 90%, and, in response, select “Best upcoming phones” to recommend to the user.

The query selection engine 240 may select the queries based on determining whether the queries have respective quality scores that satisfy a quality threshold. For example, the query selection engine 240 may select “Best upcoming phones” as the quality score of 90% is greater than a quality threshold of 65%, 70%, 80%, or some other percentage less than 90%. In another example, the query selection engine 240 may not select “Plexus 6x discount” as the quality score 60% is lower than a quality threshold of 65%, 70%, 90%, or some other percentage above 60%.

In some implementations, the query selection engine 240 may additionally or alternatively select the queries based on a maximum number and provide a corresponding card for each selected query. For example, the query selection engine 240 may select a maximum of one, two, four, or some other number of queries and select the maximum number of queries with quality scores that reflect the greatest degree of confidence. In some implementations, the query selection engine 240 may additionally or alternatively select the queries based on a minimum. For example, the query selection engine 240 may select a minimum of one, two, four, or some other number of queries with quality scores that reflect the greatest degree of confidence.

The contextual card provider 250 may obtain an indication of the one or more selected queries and, for each selected query, provide a contextual card to the client contextual module 210 where the card includes the selected query and contextual information that is a selectable link for requesting resources responsive to the selected query. For example, the contextual card provider 250 may obtain an indication that “Best upcoming phones” is selected and, in response, generate a contextual card and provide the contextual card to the client contextual module 210, where the card includes the text “Recommended Query” and “Best upcoming phones,” and includes a link that upon selection requests resources responsive to the query “Best upcoming phones.”

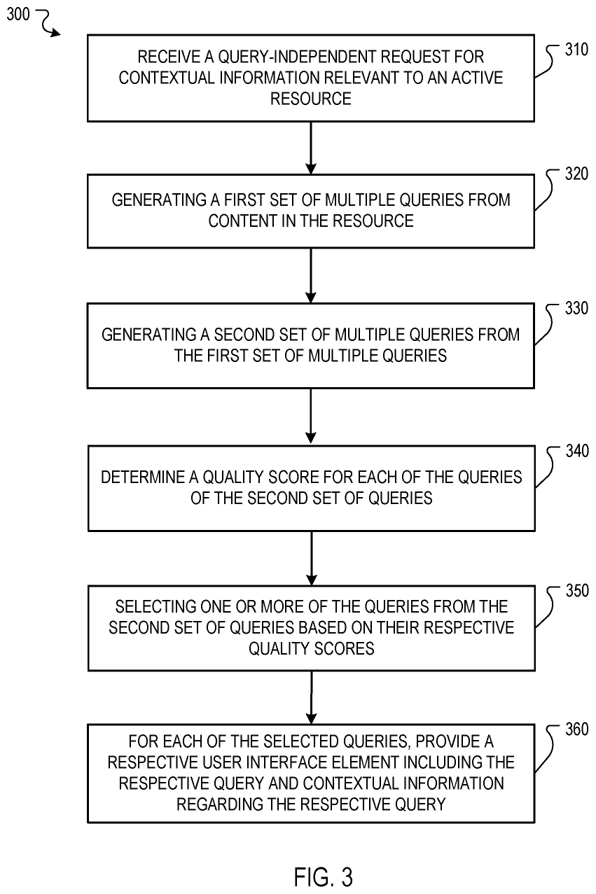

FIG. 3 is a flow diagram of a process 300 for providing contextual information for a displayed resource. For example, the process 300 can be used by the contextual information server 150 from the environment 100.

The process 300 includes receiving a query-independent request for contextual information relevant to an active resource (310). For example, the query generator 220 may receive a request that includes a document object model that defines (i) text of “Plexus 6X is now available for preorder. The Plexus 6X offers blazing performance in a compact size” and (ii) how the text is currently being displayed on a user device. In another example, the query generator 220 may receive a request that includes a screenshot of the text being displayed on a user device.

The process 300 includes generating a first set of multiple queries from displayed content in the resource (320). For example, the query generator 220 may extract the text “Plexus 6X is now available for preorder. The Plexus 6X offers blazing performance in a compact size” from a screenshot in the request or extract text “Plexus 6X is now available for preorder. The Plexus 6X offers blazing performance in a compact size” from a document object model that represents at least a portion of a resource displayed, and then generate queries that represent different words from the text in various orders.

The process 300 includes generating a second set of multiple queries from the first set of queries (330). The subsequent query identifier 222 may analyze search history logs to identify when users submit a query of the first set of queries, identify the next queries that those users submit, and then generate a set of queries including those next queries. For example, the subsequent query identifier 222 may determine that a user submitted the query “Plexus 6X” in the first set of multiple queries, then next submitted the query “Best upcoming phones” and, in response, include the query “Best upcoming phones” in the second set of multiple queries.

The process 300 includes determining a quality score for each of the queries of the second set of multiple queries (340). For example, the quality scoring engine 230 may receive the queries “Plexus 6x discount” and “Best upcoming phones” and, in response, determine a quality score of 60% for “Plexus 6X discount” as the query is submitted at a moderate amount of times after the query “Plexus 6X” is submitted and determine a quality score of 90% for “Best upcoming phones” as the query is submitted many times after the query “Plexus 6X” is submitted.

The process 300 includes selecting one or more queries based on the quality scores (350). For example, the query selection engine 240 may receive the query “Plexus 6X preorder” labeled with a quality score of 60% and the query “Best upcoming phones” labeled with the quality score of 90% and, in response, select the query “Best upcoming phones” as the quality score of 90% is higher than a quality threshold of 70% and not select the query “Plexus 6X preorder” as the quality score of 60% is below the quality threshold of 70%.

The process 300 includes, for each of the selected resources, providing a respective user interface element including the respective query and contextual information regarding the respective query (360). For example, the contextual card provider 250 may generate a contextual card that includes the text “Recommended Query” and “Best upcoming phones,” and includes a selectable link for requesting a general search using the query “Best upcoming phones” and a selectable link for requesting a news search using the query “Best upcoming phones.”

In some implementations, the process 300 can include additional steps, fewer steps, or some of the steps can be divided into multiple steps. For example, the contextual information server 150 may determine sub-quality scores based on respective factors that can be used for determining the quality scores, and then determine the quality scores by aggregating sub-quality scores.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

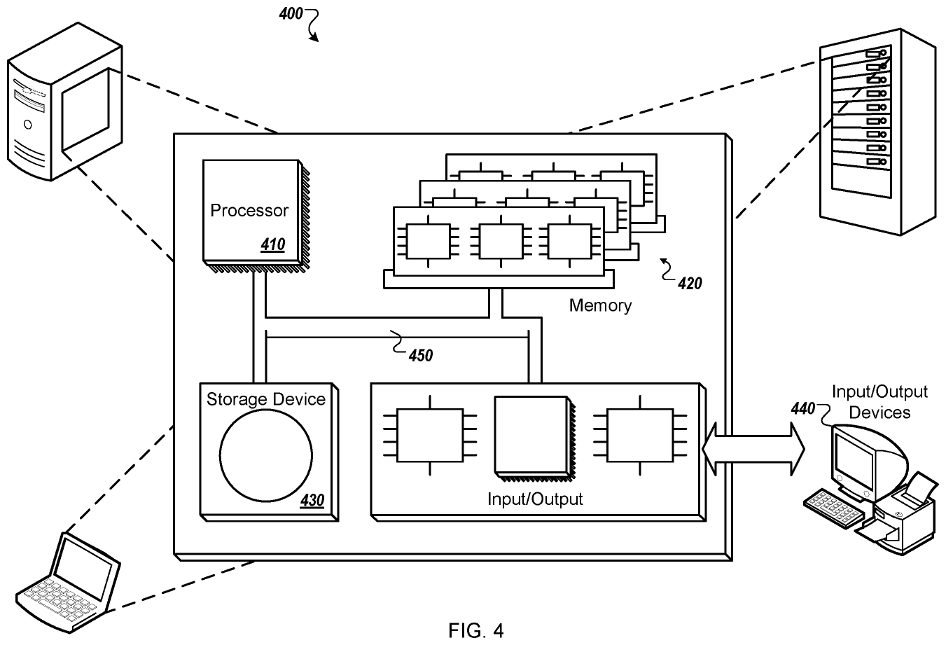

An example of one such type of computer is shown in FIG. 4, which shows a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

While this specification contains many specific implementation details, these should not be construed as limitations on the scope of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented in a data processing apparatus, the method comprising:
receiving, from a user device, a query-independent request from a user on the user device for contextual information relevant to an active resource displayed in an application environment on the user device, wherein the query-independent request is a request that does not include query parameters from the user on the user device;
generating a first set of queries, each query in the first set of queries generated from one or more terms in displayed content from the active resource;
in response to the first set of queries generated from the one or more terms, generating a second set of queries from the first set of queries using search query logs, wherein generating each query in the second set of queries comprises identifying, in the search query logs, the query as previously submitted by other users after the other users submitted queries of the first set of queries;
determining that a particular query in the second set of queries was submitted after a first query in the first set of queries and submitted after a second query in the first set of queries;
in response to determining that the particular query in the second set of queries was submitted after the first query in the first set of queries and submitted after the second query in the first set of queries, determining an aggregate number of times that the particular query in the second set of queries was submitted after the first query and submitted after the second query, wherein the aggregate number of times comprises a sum of a number of times that the particular query in the second set of queries was submitted after the first query and a number of times that the particular query in the second set of queries was submitted after the second query;
determining a quality score for each of the queries of the second set of queries, wherein:
the quality score for a given query of the second set is determined based at least in part on a visual appearance of the terms in the displayed content from which a given query of the first set was generated, the given query of the first set being the query from which the given query of the second set was generated, and
the quality score for the particular query of the second set of queries is further based on the aggregate number of times that the particular query in the second set of queries was submitted after the first query and submitted after the second query;
selecting one or more of the queries from the second set of queries based on their respective quality scores; and
providing, to the user device for each of the selected one or more queries of the second set of queries, a respective user interface element for display with the active resource, wherein each user interface element includes contextual information regarding the respective query and includes the respective query.

2. (canceled)

3. The method of claim 1, wherein the second set of queries includes queries that do not include terms that appear in the displayed content from the resource.

4. The method of claim 1, wherein determining a quality score for each of the queries of the second set of queries further comprises:
determining a frequency that a particular query of the second set of queries is submitted after a query of the first set of queries is submitted; and
determining the quality score for the particular query further based on at least the frequency that the particular query of the second set of queries is submitted after the query of the first set of queries is submitted.

5. The method of claim 1, wherein determining a frequency that a particular query of the second set of queries is submitted after a query of the first set of queries is submitted comprises:
determining, for each query of the first set of queries, a frequency that a particular query of the second set of queries is submitted after the respective query of the first set of queries is submitted; and
aggregating the frequencies for each of the first set of queries to determine the frequency that the particular query of the second set of queries is submitted after a query of the first set of queries is submitted.

6. (canceled)

7. The method of claim 1, wherein determining a quality score for each of the queries of the second set of queries further comprises:
determining a quality of search results responsive to each query of the second set of queries; and
determining the quality score for each of the queries of the second set of queries further based at least on the quality of search results responsive to the respective query.

8. The method of claim 1, wherein receiving, from a user device, a query-independent request for contextual information relevant to an active resource displayed in an application environment on the user device comprises:
receiving, from the user device, a query-independent request that does not include one or more query terms entered by a user.

9. The method of claim 1, wherein the resource comprises one or more of a web page, an application page, or a textual conversation.

10. The method of claim 1, wherein generating a second set of queries from the first set of queries comprises:
generating, for each of the queries of the first set of queries, a set of queries from the respective query; and
aggregating the sets of queries from the respective queries as the second set of queries.

11. A system comprising:
a data processing apparatus; and
a non-transitory computer readable storage medium in data communication with the data processing apparatus and storing instructions executable by the data processing apparatus and upon such execution cause the data processing apparatus to perform operations comprising:
receiving, from a user device, a query-independent request from a user on the user device for contextual information relevant to an active resource displayed in an application environment on the user device, wherein the query-independent request is a request that does not include query parameters from the user on the user device;
generating a first set of queries, each query in the first set of queries generated from one or more terms in displayed content from the active resource;
in response to the first set of queries generated from the one or more terms, generating a second set of queries from the first set of queries using search query logs, wherein generating each query in the second set of queries comprises identifying, in the search query logs, the query as previously submitted by other users after the other users submitted queries of the first set of queries;
determining that a particular query in the second set of queries was submitted after a first query in the first set of queries and submitted after a second query in the first set of queries;
in response to determining that the particular query in the second set of queries was submitted after the first query in the first set of queries and submitted after the second query in the first set of queries, determining an aggregate number of times that the particular query in the second set of queries was submitted after the first query and submitted after the second query, wherein the aggregate number of times comprises a sum of a number of times that the particular query in the second set of queries was submitted after the first query and a number of times that the particular query in the second set of queries was submitted after the second query;
determining a quality score for each of the queries of the second set of queries, wherein:
the quality score for a given query of the second set is determined based at least in part on a visual appearance of the terms in the displayed content from which a given query of the first set was generated, the given query of the first set being the query from which the given query of the second set was generated, and
the quality score for the particular query of the second set of queries is further based on the aggregate number of times that the particular query in the second set of queries was submitted after the first query and submitted after the second query;
selecting one or more of the queries from the second set of queries based on their respective quality scores; and
providing, to the user device for each of the selected one or more queries of the second set of queries, a respective user interface element for display with the active resource, wherein each user interface element includes contextual information regarding the respective query and includes the respective query.

12. (canceled)

13. The system of claim 11, wherein the second set of queries includes queries that do not include terms that appear in the displayed content from the resource.

14. The system of claim 11, wherein determining a quality score for each of the queries of the second set of queries further comprises:
determining a frequency that a particular query of the second set of queries is submitted after a query of the first set of queries is submitted; and
determining the quality score for the particular query further based on at least the frequency that the particular query of the second set of queries is submitted after the query of the first set of queries is submitted.

15. The system of claim 11, wherein determining a frequency that a particular query of the second set of queries is submitted after a query of the first set of queries is submitted comprises:
determining, for each query of the first set of queries, a frequency that a particular query of the second set of queries is submitted after the respective query of the first set of queries is submitted; and
aggregating the frequencies for each of the first set of queries to determine the frequency that the particular query of the second set of queries is submitted after a query of the first set of queries is submitted.

16. (canceled)

17. The system of claim 11, wherein determining a quality score for each of the queries of the second set of queries further comprises:
determining a quality of search results responsive to each query of the second set of queries; and
determining the quality score for each of the queries of the second set of queries further based at least on the quality of search results responsive to the respective query.

18. The system of claim 11, wherein receiving, from a user device, a query-independent request for contextual information relevant to an active resource displayed in an application environment on the user device comprises:
receiving, from the user device, a query-independent request that does not include one or more query terms entered by a user.

19. The system of claim 11, wherein the resource comprises one or more of a web page, an application page, or a textual conversation.

20. A non-transitory computer readable storage medium storing instructions executable by a data processing apparatus and upon such execution cause the data processing apparatus to perform operations comprising:
receiving, from a user device, a query-independent request from a user on the user device for contextual information relevant to an active resource displayed in an application environment on the user device, wherein the query-independent request is a request that does not include query parameters from the user on the user device;
generating a first set of queries, each query in the first set of queries generated from one or more terms in displayed content from the active resource;
in response to the first set of queries generated from the one or more terms, generating a second set of queries from the first set of queries using search query logs, wherein generating each query in the second set of queries comprises identifying, in the search query logs, the query as previously submitted by other users after the other users submitted queries of the first set of queries;
determining that a particular query in the second set of queries was submitted after a first query in the first set of queries and submitted after a second query in the first set of queries;
in response to determining that the particular query in the second set of queries was submitted after the first query in the first set of queries and submitted after the second query in the first set of queries, determining an aggregate number of times that the particular query in the second set of queries was submitted after the first query and submitted after the second query, wherein the aggregate number of times comprises a sum of a number of times that the particular query in the second set of queries was submitted after the first query and a number of times that the particular query in the second set of queries was submitted after the second query;
determining a quality score for each of the queries of the second set of queries, wherein:
the quality score for a given query of the second set is determined based at least in part on a visual appearance of the terms in the displayed content from which a given query of the first set was generated, the given query of the first set being the query from which the given query of the second set was generated, and
the quality score for a-the particular query of the second set of queries is further based on the aggregate number of times that the particular query in the second set of queries was submitted after the first query and submitted after the second query;
selecting one or more of the queries from the second set of queries based on their respective quality scores; and
providing, to the user device for each of the selected one or more queries of the second set of queries, a respective user interface element for display with the active resource, wherein each user interface element includes contextual information regarding the respective query and includes the respective query.

21. The method of claim 1, wherein determining the quality score for each of the queries of the second set of queries is further based on i) text in the active resource displayed in the application environment on the user device, ii) a query of the second set of queries that is submitted after a particular query of the first set of queries, and iii) the number of transitions from the particular query in the first set of queries to the query of the second set of queries.

22. The method of claim 1, wherein determining the quality score for each of the queries of the second set of queries is further based on a lowest average time between the average time that a particular query of the second set of queries is submitted after a first query of the first set of queries and the average time that the particular query of the second set of queries is submitted after a second query of the first set of queries.
